(19) United States
(12) Patent Application Publication
(10) Pub. No.: US 2009/0253360 A1
(43) Pub. Date: Oct. 8, 2009

(54) Portable Ventilation Unit

(76) Inventor: Craig Allen Tafoya, Ft. Lauderdale, FL (US)

Correspondence Address: DOROTHY S. MORSE, 515 PARK DRIVE, NW, BRADENTON, FL, 34209, US

(21) Appl. No.: 12/420,030

(22) Filed: Apr. 7, 2009

Related U.S. Application Data
(60) Provisional application No. 61/042,907, filed on Apr. 7, 2008.

(51) Int. Cl. B05B 15/12; B08B 15/00

(52) U.S. Cl. 454/50; 454/66

(57) ABSTRACT

A ventilation unit that can be sealed to an opening in a large temporary overspray enclosure employed during the painting of large yachts and marine vessels for containment of paint overspray, thereby substantially eliminating overspray in surrounding areas, a long sought-after objective in the industry. The unit is compact and self-contained, having a pre-filter area, primary filter material, an intake area, fans, a variable controller for each fan, an exhaust area, final discharge filters, and doors configured to seal the back end of ventilation unit during periods of non-use and which are removable during use or otherwise positionable to provide unobstructed airflow into the pre-filter area. The unit is also configured to be easily portable and reusable. A hose connection plate can also be used to connect one or more hoses to the pre-filter area to provide enhanced ventilation to high paint areas within the temporary overspray enclosure.

### CROSS-REFERENCES TO RELATED APPLICATIONS

This application is related to U.S. Provisional Patent Application 61/042,907 having the same title and similar subject matter, which was filed in the name of Craig A. Tafoya and his father, Samuel B. Tafoya, on Apr. 7, 2008. All subject matter in the claims of the instant patent application is attributable to Craig A. Tafoya. Domestic benefit from this earlier filed provisional patent application is herein requested.

### BACKGROUND

1. Field of the Invention

This invention relates to field of ventilation equipment used for large temporary enclosures employed during the painting of large yachts and marine vessels for containment of paint overspray, specifically to a mobile ventilation unit or trailer that can be connected to an opening in large temporary enclosure employed during the painting of large yachts and marine vessels for directing air containing paint overspray toward its internally-housed filters, thereby substantially eliminating the amount of overspray entering the atmosphere and contaminating surrounding areas, a goal which has long been sought but not successfully accomplished via the prior art.

2. Description of the Related Art

Every ship and yacht yard has spray painting within their facilities to apply new coatings on very large yachts. It is impossible to take any car, particularly dark and black cars, into a yacht yard and not have them covered, or at least peppered, in paint overspray before the day is out when the car happens to be positioned downwind of the application. This is even known to occur in yacht facilities recognized as a ‘GREEN FACILITY’ by state authorities. While ventilation units are currently used with these types of temporary paint enclosures to extract and filter the overspray from them, they obviously do not work effectively. Often, the ventilation units employed are purchased at local home-improvement mega-stores and the air quality they typically maintain in the spray area within the temporary enclosure is sub-standard to National Fire Protection Association (NFPA) requirements. A solution to the problem of eliminating paint overspray is long overdue. Use of the portable present invention unit maintains the air quality in the spray area of a large temporary paint overspray enclosure within the established NFPA requirements, with the large rear area of the present invention ventilation unit being one of the reasons that the present invention provides an advantage over the prior art attempts at paint overspray reduction or elimination.

### BRIEF SUMMARY OF THE INVENTION

It is the primary object of this invention to provide a ventilation unit that can be connected to an opening in a large temporary enclosure used during the painting of large yachts and marine vessels and effectively employed for containment of paint overspray in its internally-housed filters, thereby preventing the paint overspray from entering the atmosphere and contaminating surrounding area. It is also an object of this invention to provide a ventilation unit for the containment of paint overspray that is easily portable and reusable. A further object of this invention is to provide a ventilation unit for the containment of paint overspray that is intrinsically safe (explosion-proof) for use with paint. It is also an object of this invention to provide a ventilation unit for the containment of paint overspray that can be used with hoses for more targeted ventilation access to areas within the temporary enclosure having higher concentrations of paint overspray.

The present invention, when properly made and used, will provide an enclosed ventilation trailer or other mobile/portable ventilation unit that has a pre-filter area, primary filter material, an intake area, fans, a variable controller for each fan, an exhaust area, final discharge filters, and doors configured to seal the back end of ventilation unit during periods of non-use and which are removable during use or otherwise configured to provide unobstructed airflow into the pre-filter area. The pre-filter area can be sealed via shrink-wrap to the opening in a large temporary enclosure used to contain paint overspray during the painting of large yachts, to allow leak-proof fluid communication between them. In the alternative, other direct connection between the pre-filter area and an opening in the temporary enclosure can be made, or hoses can be connected to this area for targeted ventilation of additional locations, perhaps where higher amounts of pain overspray are anticipated. A hose connection plate or other mounting means can be optionally employed for the connection of one or more hoses. More than one exhaust opening covered by final discharge filter material is contemplated for the portable present invention ventilation unit, most preferably in the front end of the unit, as well as in both sides of the unit close to the front end.

The description herein provides preferred embodiments of the present invention but should not be construed as limiting its scope. For example, variations in the number, size, and type of filters used; the size of the housing of the portable unit; whether it would be in the form of a trailer; the number of fans used; the number, size, and pattern of holes used in the hose connection plate, and the manner in which the removable doors are attached and removed from the back end of the unit, other than those shown and described herein, may be incorporated into the present invention. Thus the scope of the present invention should be determined by the appended claims and their legal equivalents, rather than being limited to the examples given.

### BRIEF DESCRIPTION OF THE DRAWINGS

FIG. 1 is a top view of a most preferred embodiment of the present invention configured as a trailer and having an unobstructed rear opening, a pre-filter area, primary filter material, an intake area, fans, a variable controller for each fan, an exhaust area, final discharge filters, and doors configured to seal the back end of ventilation unit during periods of non-use and which are removable during use or otherwise configured to provide unobstructed airflow into the pre-filter area, with arrows further showing the direction of airflow through the trailer.

FIG. 2 is a side view of the most preferred embodiment of the present invention shown in FIG. 1 with its doors removed.

FIG. 3 is a side view of the most preferred embodiment of the present invention shown in FIG. 2 with its pre-filter area sealed via shrink-wrap to the opening of a large temporary enclosure used for containment of paint overspray, and arrows showing the direction of airflow through the trailer.

FIG. 4 is a back view of the most preferred embodiment of the present invention shown in FIG. 2, with fans positioned behind primary filter material and arrows showing the direction of exhaust airflow through its front sides.

FIG. 5 is a front view of a preferred hose connection plate used with the most preferred embodiment of the present invention and positioned adjacent to, or within, the pre-filter area and fans shown behind the plate.

FIG. 6 is a side view of the most preferred embodiment of the present invention shown in FIG. 2 with its pre-filter area sealed via shrink-wrap to the opening of a large temporary enclosure used for containment of paint overspray, the hose connection plate in a desired position is use and hoses connected to it, and further with arrows showing the direction of airflow through the hoses and trailer.

### DETAILED DESCRIPTION OF PREFERRED EMBODIMENTS

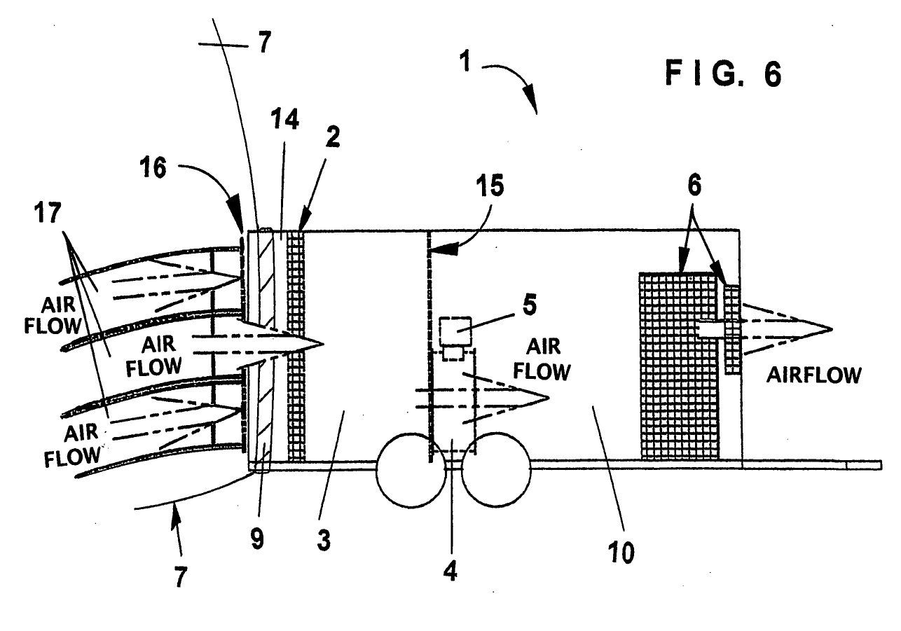

The present invention provides a portable/mobile enclosure 1, which can be in the form of an enclosed trailer having respective width and length dimensions of approximately 7 ft×16 ft, but is not limited thereto. Airflow is directed through portable/mobile enclosure 1 via fans 4 centrally located therein which are positioned and oriented to draw air through unobstructed rear opening 13 and into pre-filter area 14, and then cause the air to pass through primary filter material 2 and enter into air intake area 3. Rear opening 13 can be closed/sealed by doors 18 during periods of non-use, with doors 18 being removable during use or otherwise configured to provide unobstructed airflow through rear opening 13 and into pre-filter area 14. It is contemplated for primary filter material 2 to be configured for commercial spray facility and automotive manufacturer use. Further, during use it is contemplated for pre-filter area 14 of portable/mobile enclosure 1 to be placed in proximity to an opening 8 in a large temporary enclosure 7 used for overspray containment during painting operations, such as those used for the painting of large yachts and marine vessels (not shown). Shrink-wrapped material 9 is then secured around the pre-filter area 14 of portable enclosure 1, as well as around the adjacent opening 8 in the large temporary enclosure 7, to provide a seal that allows leak-proof fluid communication between them. In the alternative, other direct and leak-proof connection between the pre-filter area 14 of portable enclosure 1 and the opening 8 in a temporary enclosure 7 is possible, or hoses 17 (as shown in FIG. 6) via hose connection plate 16 can be connected to pre-filter area 14 to provide enhanced filtration at additional locations within temporary enclosure 7. The positioning of one or more fans 4 centrally within portable enclosure 1 is contemplated, and for each fan 4 to have a controller 5 for variable fan 4 speed. The number of fans 4 required depends upon the size of the temporary enclosure 7 and the amount of air movement (CFM) required in a given application therein. Fans 4 must be intrinsically safe (explosion-proof) for use in a high paint environment. Also, it is preferred for the pre-filter area 14 to allow the full volume of the fans 4 to be dispersed over the entire area of primary filter material 2, thus allowing less air flow (CFM) through any one portion of primary filter material 2. Thus, the greater the size of pre-filter area 14, the more advantageous. To this end, doors 18 are typically removed from portable enclosure 1 during its connection to a large temporary enclosure 7. Once the air passes through fans 4, it can optionally pass through a secondary filter (not shown) before entering exhaust area 10, where it is forced through one of several final discharge filters 6 over openings through the front and sides of portable enclosure 1. Final discharge filters 6 are configured to catch any heavy overspray particulates that may have passed through primary filter material 2 and any secondary or other filter used. Fans 4 are each preferably driven by a variable frequency drive (fan controller 5) to allow variable fan 4 speeds and differing airflow rates during different paint spraying applications. When portable enclosure 1 has been tested during the painting of a 116-ft yacht, the paint team had perfect visibility during the paint work and no paint residue in their hair, eye lashes, eye brows, etc, which typically would occur using prior art ventilation means for a large temporary enclosure 7. Additionally, the interior of large temporary enclosure 7 was clean of paint overspray and no paint overspray was left on the ground after painting was concluded. In fact, a black object placed directly in front of one of the discharge areas of portable enclosure 1 indicated a ZERO overspray discharge in that airflow exhaust area. Portable enclosure 1 is primarily designed for the large mega-yacht industry and the ship and yacht facilities that paint them. However, other applications could also be considered to be within the scope of the present invention. The enclosures 7 around yachts and employed for paint overspray are temporary and the ventilation equipment for them is typically purchased from a local home-improvement mega-store. The spray area within the temporary enclosures 7 is typically maintained at less than National Fire Protection Association (NFPA) requirements by prior art ventilation units, whereas the present invention maintains the air quality in the temporary enclosures 7 well within the established requirements.

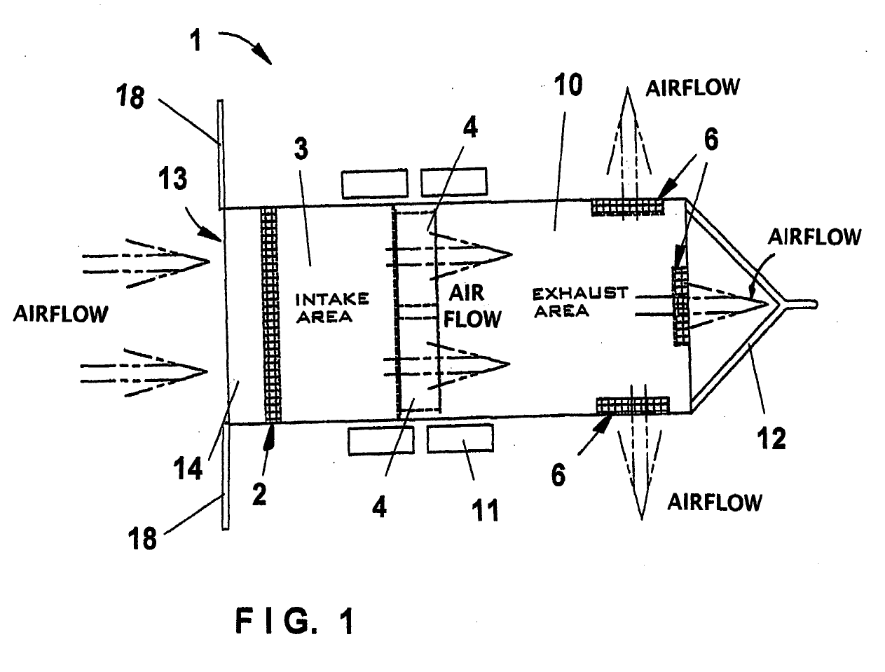

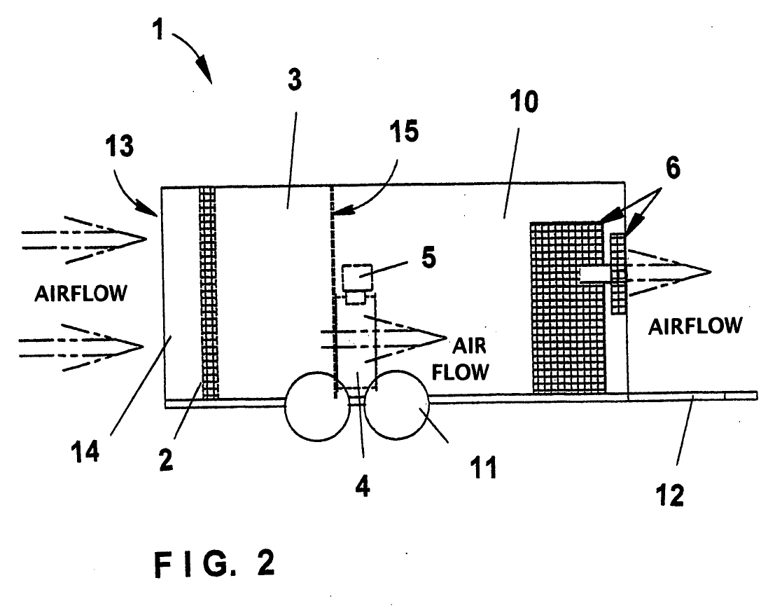

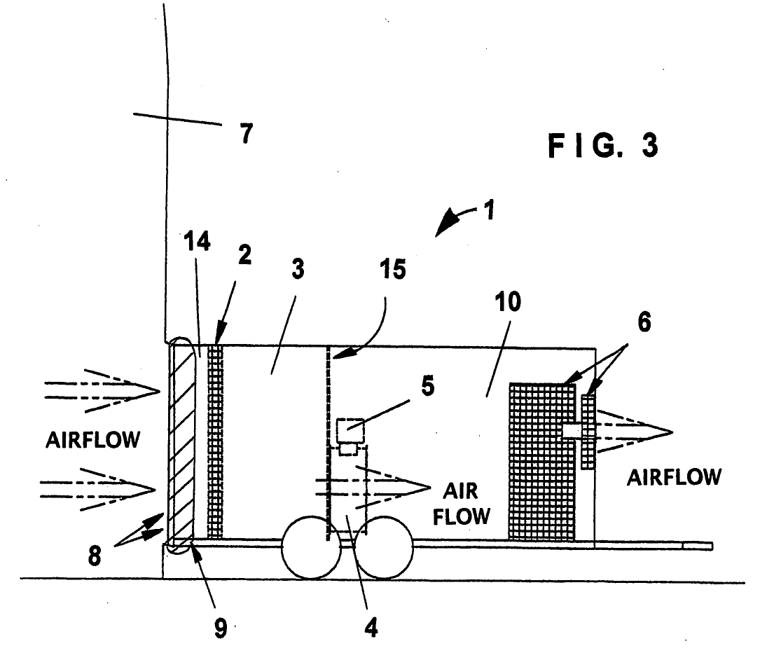

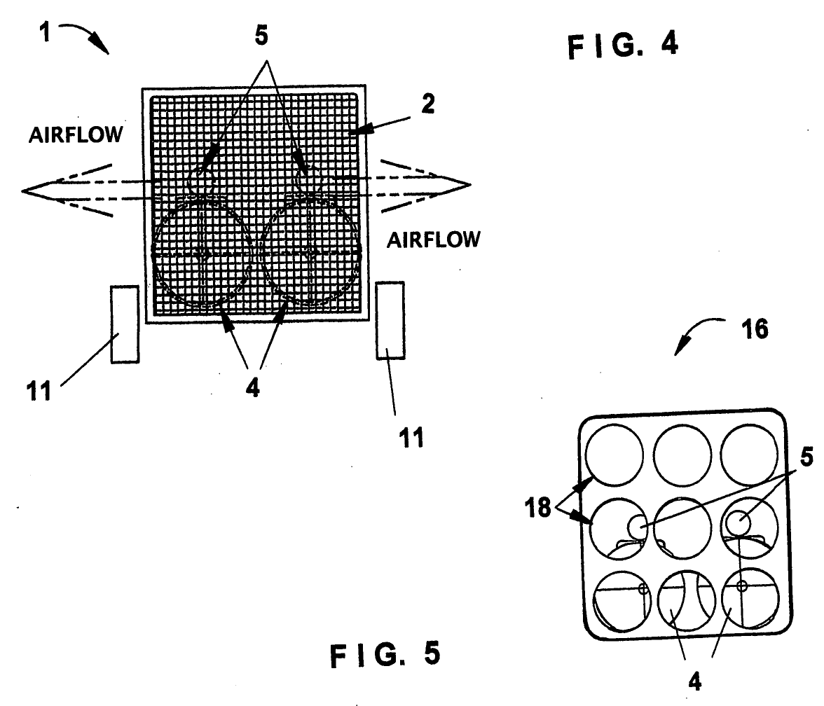

FIGS. 1-4 show the most preferred embodiment of the present invention portable enclosure 1 configured as an enclosed trailer. Large arrows in FIGS. 1-4 show the direction of airflow through portable enclosure 1. FIG. 1 is a top view showing portable enclosure 1 having an unobstructed rear opening 13, a pre-filter area 14, primary filter material 2 extending from the top interior surface of portable enclosure 1 to its bottom interior surface, a large air intake area 3 in fluid communication with fans 4 (two of which are shown), a large exhaust area on the opposite side of fans 4 remote from intake area 3, final discharge filters 6 (three of which are shown in separate areas at the front and sides of portable enclosure 1), and doors 18 configured to seal the pre-filter area 14 during periods of portable enclosure 1 non-use and which are preferably configured to be removable during use of portable enclosure 1, or otherwise configured to provide unobstructed airflow into pre-filter area 14. FIG. 1 also shows wheels 11 and a forward A-frame assembly used for providing mobility/portability. FIG. 2 is a side view of the most preferred embodiment of portable enclosure 1, with doors 18 removed and a controller 5 associated with fan 4 for adjusting its according to the airflow rate needed in differing paint spraying applications. FIG. 2 also shows a barrier 15 above fans 4 that is configured to block direct movement of air from intake area 3 to exhaust area 10, and instead cause all airflow to be directed through fans 4. FIG. 3 is a side view of the most preferred embodiment of portable enclosure 1 with its pre-filter area 14 sealed via shrink-wrap 9 to the opening 8 of a large temporary enclosure 7 used for containment of paint overspray (not shown), while FIG. 4 is a back view of the most preferred embodiment of portable enclosure 1 with fans 4 shown positioned behind primary filter material 2 which extends substantially from top-to-bottom and side-to-side within the interior of portable enclosure 1, a controller 5 associated with each fan 4, wheels 11 supporting portable enclosure 1 in a manner to provide it with mobility, and arrows showing the direction of exhaust airflow through the front sides of portable enclosure 1.

FIGS. 5 and 6 show an optional hose connection of portable enclosure 1 to a large temporary overspray enclosure 7 using a hose connection plate 16 having multiple holes 18. The number, size, location, spaced-apart positioning, and perimeter configuration of holes 18 are not critical as shown in FIG. 5, and instead hose connection plate 16 may comprise four larger holes 18 or another configuration that permits enhanced elimination of paint overspray in targeted areas within large temporary enclosure 7. Further, the size of hose connection plate 16 may be sufficiently large to or hose connection plate 16 may have a smaller configuration. FIG. 5 is a front view of a preferred hose connection plate 16 used with portable enclosure 1, and positioned adjacent to, or within, the pre-filter area 14. The relative size of fans 4 and controllers 5 are shown behind hose connection plate 16 when hose connection plate 16 has a dimension that would fit fully within pre-filter area 14. However, the configuration shown is only one preferred embodiment, and is not critical. FIG. 6 is a side view of the most preferred embodiment of portable enclosure 1 with its pre-filter area 14 sealed via shrink-wrap 9 to the opening 8 (see FIG. 3) of a large temporary enclosure 7 used for containment of paint overspray during the painting of large yachts (not shown). A hose connection plate 16 is in a desired position of use with hoses 17 connected to it. FIG. 6 further has arrows showing the direction of airflow through hoses 17 and portable enclosure 1.

I claim:

1. A portable and reusable ventilation unit that can be sealed to an opening in a large temporary overspray enclosure employed during painting for containment of paint overspray, including the painting of large yachts and marine vessels, said ventilation unit comprising:
a housing having a front end, an open back end, and two opposing side walls extending between said front end and said open back end, a pre-filter area associated with said open back end, an exhaust area associated with said front end and having at least one exhaust opening, and an intake area located between said pre-filter area and said exhaust area;
at least one door movable from a closed position sealing said open back end in said housing during periods of non-use to at least one open position that provides unobstructed airflow into said pre-filter area;
primary filter material located in said pre-filter area;
at least two fans located in said intake area;
a controller for each of said fans; and
final discharge filter material covering said at least one exhaust opening, so that when said open back end of said housing is connected to a large temporary overspray enclosure employed during painting, operation of said fans in said housing draws air from said large temporary overspray enclosure through said primary filter material in said pre-filter area, through said intake area, and said final discharge material, and thereby substantially eliminates paint overspray in areas surrounding said housing and the temporary overspray enclosure.

2. The ventilation unit of claim 1 wherein said housing had a compact configuration and is self-contained.

3. The ventilation unit of claim 1 further comprising a hose connection plate that is configured for use in connecting at least one hose to said open back end.

4. The ventilation unit of claim 1 wherein said at least one door is removable from said housing.

5. The ventilation unit of claim 1 further comprising a quantity of skrink-wrap material and wherein said shrink-wrap material is positioned to seal said pre-filter area to an opening in a large temporary overspray enclosure.

6. The ventilation unit of claim 1 wherein said primary filter material and said final discharge filter material are configured and dimensioned to together provide sufficient filtering capability to maintain the air quality in the spray area of the large temporary overspray enclosure to which said ventilation unit is attached within the established NFPA requirements

7. The ventilation unit of claim 1 wherein said fans and said variable controllers for said fans are configured for explosion-proof use.

8. The ventilation unit of claim 1 wherein said at least one exhaust opening is located through said front end of said housing.

9. The ventilation unit of claim 1 having at least two exhaust openings and wherein at least one of said exhaust openings is located through said front end of said housing, and also wherein at least one of said exhaust openings is located through one of said side walls of said housing close to said front end.

10. The ventilation unit of claim 1 having at least three exhaust openings and wherein at least one of said exhaust openings is located through said front end of said housing, at least one of said exhaust openings is located through one of said side walls of said housing close to said front end, and at least one of said exhaust openings is located through the opposed one of said side walls of said housing close to said front end.

11. The ventilation unit of claim 1 wherein said housing is in the form of a portable trailer.

12. The ventilation unit of claim 1 wherein said controller for at least one of said fans is a variable speed controller.

13. The ventilation unit of claim 1 wherein said fans are centrally positioned within said housing.

14. The ventilation unit of claim 1 further comprising secondary filter material between said primary filter material and said exhaust area.

15. The ventilation unit of claim 1 wherein said fans, primary filter material, and said pre-filter area are configured and positioned to allow the full volume of said fans to be substantially dispersed over the entire area of said primary filter material.

16. The ventilation unit of claim 1 wherein said housing has at least one interior barrier between said intake area and said exhaust area, with said barrier configured for directing air flow through said fans.

17. A method for using the ventilation unit of claim 1 to prevent paint overspray produced in a large temporary overspray enclosure employed during painting, including the painting of large yachts and marine vessels, from reaching areas surrounding the temporary overspray enclosure, said method comprising the steps of:
providing the ventilation unit of claim 1, a large temporary overspray enclosure with an opening and shrink-wrap material;
aligning said open back end of said housing with said opening in said large temporary overspray enclosure;
using said shrink-wrap material to provide a leak-proof connection between said open back end and said opening; and
activating said fans to direct air in said large temporary overspray enclosure to enter said open back end and travel through said primary filter material and said final discharge filter material, before the air traveling through said housing exits it through said at least one exhaust opening in said exhaust area wherein paint overspray in air from said large temporary overspray enclosure traveling through said housing is stopped by said primary filter material and said final discharge filter material and does not exit said housing into areas surrounding said housing and said large temporary overspray enclosure.

18. The method of claim 15 further comprising the step of providing at least one hose connection plate, and the step of providing leak-proof sealing between said hose connection plate and said open back end of said housing.

19. The method of claim 15 wherein said fans and said variable controllers for said fans are configured for explosion-proof use.

20. The method of claim 15 wherein said controller for at least one of said fans is a variable speed controller.
